(19) United States
(12) Patent Application Publication
(10) Pub. No.: US 2026/0310614 A1
(43) Pub. Date: Oct. 8, 2026

(54) COMPUTING DEVICE CONTROL USING A LARGE LANGUAGE MODEL

(71) Applicant: CargoSense, Inc., Reston, VA (US)

(72) Inventor: Richard Allen Christopher KILMER, Centreville, VA (US)

(73) Assignee: CargoSense, Inc., Reston, VA (US)

(21) Appl. No.: 19/636,622

(22) Filed: Apr. 1, 2026

Related U.S. Application Data
(60) Provisional application No. 63/782,670, filed on Apr. 3, 2025.

(51) Int. Cl. G06F 13/10; G05B 13/02; G06F 9/451

(52) U.S. Cl. CPC G06F 13/10; G05B 13/027; G06F 9/451; G06F 2213/40

(57) ABSTRACT

A system for operating computing devices using large language models (LLM(s)) is provided. The system comprises a processing unit comprising one or more processors configured to execute the LLM(s); a keyboard-video-mouse (KVM) interface configured to receive output data from the computing devices and transmit input data to the computing devices; and memory storing instructions. The system receives output data from the computing devices via the KVM interface; transforms, based on a display communication protocol, the received output data to graphical user interface (GUI) image data; processes, using the LLM(s), the GUI image data to generate at least one control command corresponding to at least one interaction with the computing devices; transforms the at least one control command into corresponding input data based on a keyboard communication protocol, a mouse communication protocol, or both; and transmits the input data to the one or more computing devices via the KVM interface.

### CROSS-REFERENCE TO RELATED APPLICATIONS

This application claims the benefit of U.S. Provisional Application No. 63/782,670, filed Apr. 3, 2025, the entire contents of which are incorporated herein by reference.

### FIELD

The present disclosure relates generally to computing device control and specifically to control using a large language model.

### BACKGROUND

Known techniques for remotely connecting to and/or controlling a computer include software-based solutions, such as those utilizing Remote Desktop Protocol or Virtual Network Computing. Such techniques may involve transmitting graphical user interface data over a network while receiving user input from a remote keyboard and mouse. These methods may involve software installation on the target computing device, enabling a remote client to interact with the computing device as though physically present. Such software installations may introduce security risks, dependency on network connectivity, and/or compatibility issues arising from software updates.

Hardware-based remote access solutions, such as digital keyboard-video-mouse (KVM) switches, may provide an alternative approach to computing device control by receiving video output and transmitting keyboard and mouse inputs. Such digital KVM solutions may involve transmitting video data over a network while receiving user input from a remote keyboard and mouse. Known KVM systems may be limited to control by a human operator and may not involve autonomous decision-making by the system itself.

Known techniques involving use of predefined scripts or macros may enable a computing device to perform repetitive tasks without direct user input. However, these approaches may involve providing static instructions and may not include the ability to adapt to changes in the computing environment, such as unexpected graphical user interface (GUI) responses and/or system states, and may lack the ability to learn from prior interactions. As a result, such techniques may include frequent manual updates to maintain functionality.

### SUMMARY

Disclosed herein are systems and methods for operating computing devices using a set of one or more large language models (LLMs) in conjunction with a digital KVM interface. As discussed above, known techniques for remote computing device control involve software-based solutions that may introduce security risks and/or network dependencies and hardware-based solutions that involve direct human operation without autonomous decision-making. Similarly, automation techniques based on predefined scripts or macros typically lack adaptability, failing to adjust to unexpected responses or learn from prior interactions.

Disclosed systems and methods may address these shortcomings by enabling automation that may replace one or more functions typically carried out by a human operator. An exemplary system may process display output from one or more computing devices using one or more LLMs and generate keyboard and mouse inputs to interact with the one or more computing devices via the digital KVM interface. For example, the digital KVM interface may receive output data via a display communication protocol and may transmit input data via a keyboard communication protocol and/or a mouse communication protocol, enabling device control without software installation on the one or more computing devices. The system may transform received output data to GUI image data and process the GUI image data using the set of one or more LLMs which may include, for example, one or more multimodal LLMs. The set of one or more LLMs may reason over the processed GUI image data to generate corresponding control commands, which may be transformed into simulated keystrokes, simulated mouse movements, and/or simulated mouse clicks for transmission to the one or more computing devices. By iterating through this process cyclically, the system may continuously refine its interactions based on newly received GUI image data, ensuring responsiveness to changing GUI states.

In some implementations, the system may further include a network communication module, such as a cellular antenna, enabling system updates and external connectivity while remaining isolated from the network of the controlled one or more computing devices. An exemplary system may locally execute the LLM on a high-performance processing unit, allowing it to analyze GUI elements, determine appropriate interactions, and transmit corresponding keyboard and mouse inputs to the one or more computing devices. The system may further incorporate learning mechanisms to refine future interactions based on prior outcomes, enabling the system to adapt to changing software environments and address unexpected GUI responses. For example, the system may store past control commands and/or corresponding GUI states in memory, enabling adjustment of future interactions based on observed successes or failures.

In some embodiments, a system for operating one or more computing devices using a set of one or more large language models (LLM(s)) is provided, the system comprising: a processing unit comprising one or more processors configured to execute the LLM(s); a keyboard-video-mouse (KVM) interface, wherein the KVM interface is configured to receive output data from the one or more computing devices via a display communication protocol and transmit input data to the one or more computing devices via a keyboard communication protocol, a mouse communication protocol, or both; and memory storing instructions that, when executed by the one or more processors of the processing unit, cause the system to: receive output data from the one or more computing devices via the KVM interface; transform, based on the display communication protocol, the received output data to graphical user interface (GUI) image data; process, using the LLM(s), the GUI image data to generate at least one control command corresponding to at least one interaction with the one or more computing devices; transform the at least one control command into corresponding input data based on the keyboard communication protocol, the mouse communication protocol, or both; and transmit the input data to the one or more computing devices via the KVM interface.

In some embodiments, the processing unit is configured to execute the LLM(s) locally on the processing unit without transmitting inference requests to an external computing system. In some embodiments, the memory stores one or more model parameters of the LLM(s), enabling execution of the LLM(s) without data retrieval from an external computing system. In some embodiments, the instructions further cause the system to: monitor GUI image data generated by the one or more computing devices in response to the transmitted input data to determine whether the transmitted input data resulted in an expected response; and generate at least one second control command based on the determination. In some embodiments, the LLM(s) include one or more multimodal LLMs and processing the GUI image data to generate at least one control command comprises analyzing, using the one or more multimodal LLMs, the GUI image data to identify one or more elements of the GUI. In some embodiments, generating the at least one control command comprises processing audio data received by the KVM interface from the one or more computing devices. In some embodiments, the instructions cause the system to process the received output data by: extracting at least one image frame representing a graphical user interface (GUI) of the one or more computing devices; identifying, using one or more computer vision techniques, one or more elements of the GUI based on the at least one extracted image frame; constructing a prompt for the LLM(s) based on a textual representation of the identified one or more GUI elements; and processing the prompt using the LLM(s) to generate the at least one control command corresponding to the at least one interaction with the one or more computing devices. In some embodiments, the one or more computer vision techniques comprise optical character recognition, edge detection, or both. In some embodiments, the instructions cause the system to process the prompt using the LLM to generate the at least one control command by determining one or more functional relationships between the identified one or more elements of the GUI. In some embodiments, the instructions cause the system to transform the at least one control command into corresponding input data based on the keyboard communication protocol by transforming the at least one control command into one or more simulated keystrokes. In some embodiments, the instructions cause the system to transform the at least one control command into corresponding input data based on the mouse communication protocol by transforming the at least one control command into one or more simulated mouse movements, one or more simulated mouse clicks, or both. In some embodiments, the transmitted input data comprise one or more USB packets. In some embodiments, the system further comprises a network communication module configured to connect the processing unit to an external network. In some embodiments, the external network is separate from a network to which at least one of the one or more computing devices is connected. In some embodiments, the system further comprises a cellular antenna and the external network comprises a cellular network. In some embodiments, the processing unit is configured to receive one or more system updates via connection to the external network.

In some embodiments, a method for operating one or more computing devices using a set of one or more large language models (LLM(s)) is provided, the method comprising: receiving output data from the one or more computing devices via a KVM interface; transforming, based on a display communication protocol, the received output data to graphical user interface (GUI) image data; processing, using the LLM(s), the GUI image data to generate at least one control command corresponding to at least one interaction with the one or more computing devices; transforming the at least one control command into corresponding input data based on a keyboard communication protocol, a mouse communication protocol, or both; and transmitting the input data to the one or more computing devices via the KVM interface.

In some embodiments, a non-transitory computer readable storage medium storing instructions for operating one or more computing devices using a set of one or more large language models (LLM(s)) is provided, wherein the instructions, when executed by one or more processors of an electronic device, cause the device to: receive output data from the one or more computing devices via a KVM interface; transform, based on a display communication protocol, the received output data to graphical user interface (GUI) image data; process, using the LLM(s), the GUI image data to generate at least one control command corresponding to at least one interaction with the one or more computing devices; transform the at least one control command into corresponding input data based on a keyboard communication protocol, a mouse communication protocol, or both; and transmit the input data to the one or more computing devices via the KVM interface.

In some embodiments, a system for operating one or more computing devices using a set of one or more large language models (LLM(s)) is provided, the system comprising: a processing unit comprising one or more processors configured to execute the LLM(s); a keyboard-video-mouse (KVM) interface, wherein the KVM interface is configured to receive output data from the one or more computing devices via a display communication protocol and transmit input data to the one or more computing devices via a keyboard communication protocol, a mouse communication protocol, or both; and memory storing instructions that, when executed by the one or more processors of the processing unit, cause the system to: receive output data from the one or more computing devices via the KVM interface; process, using the LLM(s), the output data, or data derived therefrom, to generate at least one control command corresponding to at least one interaction with the one or more computing devices; and transmit the at least one control command, or data derived therefrom, to the one or more computing devices via the KVM interface.

In some embodiments, a method for operating one or more computing devices using a set of one or more large language models (LLM(s)) is provided, the method comprising: receiving output data from the one or more computing devices via a KVM interface; processing, using the LLM(s), the output data, or data derived therefrom, to generate at least one control command corresponding to at least one interaction with the one or more computing devices; and transmitting the at least one control command, or data derived therefrom, to the one or more computing devices via the KVM interface.

In some embodiments, a non-transitory computer readable storage medium storing instructions for operating one or more computing devices using a set of one or more large language models (LLM(s)) is provided, wherein the instructions, when executed by one or more processors of an electronic device, cause the device to: receive output data from the one or more computing devices via a KVM interface; process, using the LLM(s), the output data, or data derived therefrom, to generate at least one control command corresponding to at least one interaction with the one or more computing devices; and transmit the at least one control command, or data derived therefrom, to the one or more computing devices via the KVM interface.

In some embodiments, any of the features of any of the embodiments described above and/or described elsewhere herein may be combined, in whole or in part, with one another. Additional advantages will be readily apparent to those skilled in the art from the following figures and detailed description. The aspects and descriptions herein are to be regarded as illustrative in nature and not restrictive.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying figures of which:

FIG. 1A depicts an exemplary system for operating computing device using a set of one or more LLMs communicatively coupled to a computing device, according to some embodiments.

FIG. 1B depicts an exemplary system for operating computing devices using a set of one or more LLMs, according to some embodiments.

FIG. 2 depicts an exemplary process for operating computing devices using a set of one or more LLMs, according to some embodiments.

FIG. 3 depicts an exemplary computing system, according to some embodiments.

### DETAILED DESCRIPTION

Disclosed herein are systems and methods for operating one or more computing devices using one or more LLMs in conjunction with a digital KVM interface. By using a high-performance processing unit in conjunction with a digital KVM interface, an exemplary system may facilitate computing device operation without involving installation of software on the one or more computing devices. Unlike traditional remote access or automation solutions, an exemplary system may replace one or more functions of a human operator, receiving display output data from the one or more computing devices, analyzing GUI images using the one or more LLMs, and generating control commands and corresponding keyboard and mouse input data to enable autonomous interaction with the one or more computing devices.

An exemplary system may include a high-performance processing unit, memory, and a digital KVM interface, enabling the system to connect to the one or more computing devices via standard display and input interfaces such as USB-C, HDMI, and/or DisplayPort. The system may receive GUI image data from the one or more computing devices, process it locally using the one or more LLMs, and generate corresponding control commands. Such control commands may be transformed into simulated keystrokes, simulated mouse movements, and/or simulated mouse clicks, which may then be transmitted to the one or more computing devices via the digital KVM interface, allowing the system to perform user-like interactions. In some implementations, one or more multimodal LLMs may process raw GUI images directly, while one or more text-based LLMs may process prompts based on structured textual descriptions of the GUI to determine appropriate interactions with the one or more computing devices. By iterating through this process in a cyclic manner, an exemplary system may continuously adapt to changes in the GUI, monitor execution outcomes, and/or refine interactions and control commands in real-time.

Unlike software-based remote access solutions that may involve installation on the target computing device and may depend on network connectivity, disclosed systems and methods may operate independently of the one or more computing devices'network environment, providing an air-gapped, secure solution. In some implementations, a cellular network module may be included to allow an exemplary system to receive updates and/or be remotely monitored while remaining isolated from the one or more computing devices'network. An exemplary system may learn from prior interactions, adjusting control strategies based on observed GUI responses to improve accuracy and efficiency over time.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed terms. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, storage medium, such as, but not limited to, any type of disk, including floppy disks, USB flash drives, external hard drives, optical disks, CD-ROMs, magneto-optical disks, read-only memories (ROMs), random access memories (RAMs), EPROMs, EEPROMs, magnetic or optical cards, application-specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear in the description below. In addition, the present invention is not described with reference to any particular programming language. It will be appreciated that a variety of programming languages may be used to implement the teachings of the present disclosure as described herein.

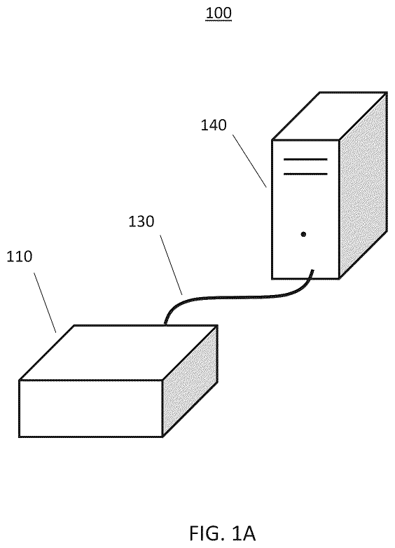

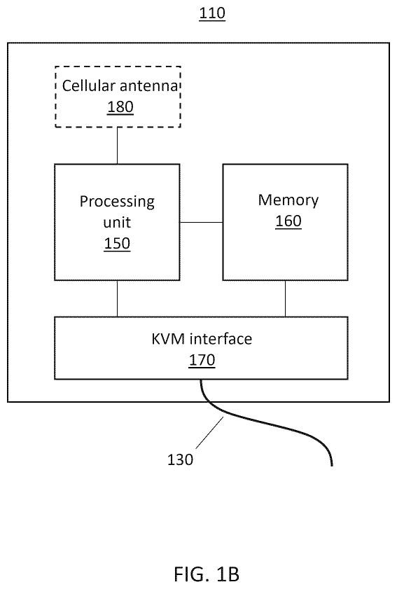

FIG. 1A depicts a view 100 that includes an exemplary system 110 for operating a computing device using a set of one or more LLMs. System 110 may include a processing unit, for example a high-performance processing unit. In some implementations, system 110 may include a GPU-based processing unit including, for example, NVIDIA GPUs (as used in the NVIDIA Sparks computer), Google Tensor Processing Units, and/or Intel Gaudi AI Accelerators, that may be configured to execute computationally intensive operations. The GPU-based processing unit may incorporate high-performance processors optimized for parallel computation, enabling execution of resource-intensive workloads such as machine learning models and/or computer vision algorithms locally on the processing unit. In some implementations, system 110 may include high-performance computing components designed to accelerate machine learning or LLM-based processes including, for example, dedicated processor cores and/or high-bandwidth memory.

System 110 may further include a digital KVM interface enabling communication with one or more computing devices, such as computing device 140 depicted in FIG. 1A. The digital KVM interface of system 110 may be communicatively coupled to one or more computing devices such as computing device 140 depicted in FIG. 1A. The digital KVM interface may be communicatively coupled via one or more wires such as wire 130 depicted in FIG. 1A. Wire 130 may enable a wired communication link between system 110 and computing device 140, for example enabling bidirectional data transmission with video output data transferring from computing device 140 to system 110 and keyboard and/or mouse input data transferring from system 110 to computing device 140. For example, wire 130 may include, for example, a USB-C connection, a DisplayPort connection, an HDMI connection, a Thunderbolt connection, and/or another high-speed digital interface capable of enabling transmission of video output signals and keyboard and/or mouse input signals. In some implementations, the digital KVM interface and/or another interface of system 110 may receive audio output data from computing device 140. Audio data may be received as a part of and/or in addition to the video output data transferring from computing device 140. For example, audio output data may be received via an HDMI interface and/or another communication path. The received audio output data may correspond to system sounds, alerts, media playback, accessibility output, and/or application-generated audio. In some embodiments, generating the at least one control command comprises processing audio data with the GUI image data. Audio data may, in some embodiments, be received as part of the received output data. Audio data may, in some embodiments, be processed along with the GUI image data by, for example, a multimodal LLM and/or other model.

In some implementations, for example as depicted in FIG. 1A, system 110 may be configured to function as an air-gapped controller, isolating the processing unit from the network of computing device 140. For example, system 110 may operate independently from computing device 140's network environment while maintaining external connectivity via a network communication module. An exemplary network communication module may be configured to connect the processing unit to an external network. For example, the external network may include a cellular network and the network communication module may include a cellular antenna. Such an external network communication configuration may allow system 110 to receive system updates, to be remotely monitored, and/or to be externally controlled while ensuring that computing device 140 remains secure from unauthorized access.

System 110 may be implemented as a standalone device or as part of a broader computing infrastructure supporting multiple computing devices. In some implementations, multiple instances of systems such as system 110 may be deployed across an enterprise network, each interfacing with a distinct computing device such as computing device 140. In such implementations, the systems may share a common update and management framework, enabling centralized control over software updates, configuration settings, and/or operator monitoring. For example, such a framework may facilitate automatic and/or scheduled updates across multiple systems, ensuring performance and/or security consistency without involving repetitive intervention with individual units.

FIG. 1B depicts an exemplary configuration of system 110, illustrating various components that may be included in the system. As shown, system 110 may include a processing unit 150, a memory 160, a digital KVM interface 170, a cellular antenna 180 and wire 130 to communicatively couple digital KVM interface 170 to one or more computing devices such as computing device 140 depicted in FIG. 1A. Processing unit 150 may include one or more processors configured to execute computationally intensive tasks, including but not limited to executing LLM-based operations, processing GUI image data, and/or generating control commands. In some implementations, processing unit 150 may include a GPU-based architecture optimized for parallel computing, such as a system based on NVIDIA GPUs, Google Tensor Processing Units, and/or Intel Gaudi AI Accelerators, enabling high-speed inference and real-time processing to be conducted locally on processing unit 150.

In some implementations, processing unit 150 may include hardware units optimized for running machine learning models and/or neural networks efficiently with lower power consumption to enhance performance of AI-driven tasks. For example, processing unit 150 may incorporate tensor cores for accelerating deep learning computations, CUDA cores for parallel processing, and/or deep learning accelerators to optimize inference tasks. Additionally or alternatively, processing unit 150 may include high-speed interconnects, such as NVLink, to enable efficient data transfer between multiple processing units, further increasing performance.

Memory 160 may store instructions and/or data used during operation of system 110. In some implementations, memory 160 may include volatile memory, such as dynamic random-access memory, to support real-time processing operations, and/or non-volatile memory, such as flash storage, to retain system configurations, firmware, and/or model parameters. Memory 160 may be configured to support fast read and write operations, ensuring low-latency access to data that may be requested by processing unit 150. Additionally or alternatively, memory 160 may be optimized for handling execution of large machine learning models, for example by enabling storage and retrieval of neural network weights and/or intermediate processing results. Memory 160 may support secure storage techniques, such as encryption and/or access control, to ensure data integrity and/or to prevent unauthorized access. Memory 160 may be configured to interface directly with processing unit 150 via high-bandwidth communication channels.

Digital KVM interface 170 may enable communication between system 110 and one or more computing devices, such as computing device 140, via one or more wired connections, such as wire 130. As mentioned above, wire 130 may support various communication standards, including USB-C, DisplayPort, HDMI, and/or Thunderbolt, enabling compatibility with different computing environments. Digital KVM interface 170 may facilitate transmission of video output data from computing device 140 to system 110 and transmission of keyboard and/or mouse input data from system 110 to computing device 140. System 110 may include cellular antenna 180, enabling external connectivity for system updates, remote monitoring, and/or administrative control while remaining isolated from computing device 140's local network. Cellular antenna 180 may support multiple frequency bands and/or network standards, such as 4G LTE or 5G, enabling connectivity in various locations.

In some implementations, cellular and/or other network connectivity of system 110 may be selectively enabled or disabled, for example by using one or more software controls. In some implementations, cellular and/or other network connectivity of system 110 may be selectively enabled or disabled by physically inserting or removing, and/or physically connecting or disconnecting, a communication device and/or component such as a cellular module and/or a SIM card. This configuration may allow system 110 to be used in secure environments where network communication may be restricted and/or prohibited, ensuring that network connectivity can be disabled and/or communication capabilities can be removed when desired.

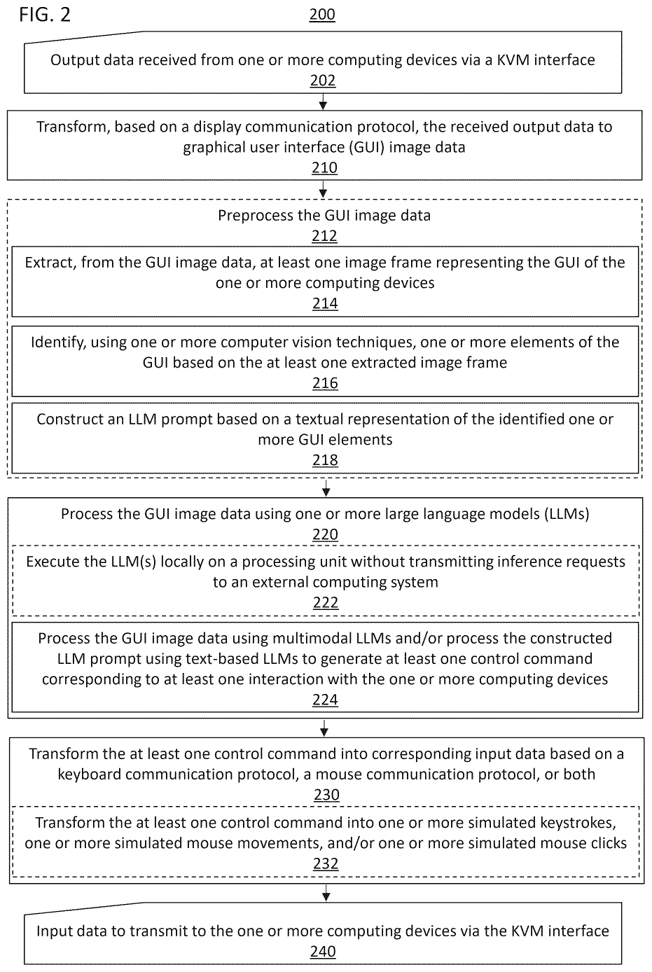

FIG. 2 depicts an exemplary process 200 for operating one or more computing devices using a system employing one or more LLMs and a digital KVM interface such as system 110. Process 200 may involve receiving and processing output video data from the one or more computing devices corresponding to GUI image data to generate control commands that enable interaction with the one or more computing devices. As shown, process 200 may begin with receipt of output data 202 from one or more computing devices via a digital KVM interface. For example, output data 202 may be transferred from a computing device such as computing device 140 to digital KVM interface 170 via wire 130. In some implementations, the received output data may include display signals transmitted over a display communication protocol including, for example, HDMI, DisplayPort, and/or USB-C video. As described in more detail below, system 110 may capture and process this output data to extract relevant GUI elements for analysis.

Output data 202 may correspond to some or all of the visual state of a computing device's GUI at a given time, enabling system 110 to reason over its contents. In some implementations, output data 202 may include a complete frame capture of the entire GUI, capturing for example all active windows and UI elements. In other implementations, output data 202 may include a cropped or selectively extracted portion of the GUI focusing on, for example, specific application windows, menus, and/or interface elements. Additionally or alternatively, the resolution of output data 202 may vary based on processing engine and/or bandwidth constraints associated with system 110 and/or on any task-specific requirements. For example, high-definition output data may be used for detailed GUI analysis, while output data corresponding to down selected or lower-resolution frames may be used to optimize computational efficiency and/or to reduce processing latency. In some implementations, system 110 may adjust the level of detail in output data 202 based on resource availability, enabling GUI fidelity to be balanced with performance. In some implementations, output data 202 may include audio data associated with the GUI state of the one or more computing devices. For example, the audio data may include system sounds, spoken prompts, alerts, media playback, accessibility output, and/or other application-generated audio.

At step 210, received output data 202 may be transformed, based on the relevant display communication protocol, into GUI image data. This transformation may involve decoding the video signal of output data 202 based on the relevant protocol, extracting individual frames, and storing the extracted frames as GUI image data for further processing. In some implementations, decoding output data 202 may include extracting pixel data from compressed or encoded formats and converting the data into a standard bitmap or rasterized image format.

System 110 may optimize this transformation by selecting a set of properties including image resolution, color format, and/or compression level to generate GUI image data that balances computational efficiency and GUI image data quality. For example, if a task involves high-fidelity GUI analysis, system 110 may retain full-resolution images, whereas for resource or bandwidth-constrained environments, output data 202 may be down sampled to reduce computational overhead. In some implementations, system 110 may capture frames at predefined intervals and/or based on detected GUI state changes to minimize redundant processing of static GUI elements.

As described below, GUI image data may next be analyzed to identify relevant GUI elements and/or to infer interactions between elements. In some implementations, GUI image data may include metadata corresponding to, for example, image frame timestamps, cursor positions, and/or display settings, providing an LLM contextual data for each GUI image.

At step 212, system 110 may optionally preprocess GUI image data by first, at sub-step 214, extracting at least one image frame representing the GUI of the one or more computing devices. Extracted image frames may correspond to full-screen captures, active application windows, and/or specific GUI elements, depending on the configuration of system 110 and/or the current task. At sub-step 216, system 110 may identify one or more elements of the GUI using one or more computer vision techniques. For example, system 110 may apply computer vision techniques including optical character recognition to extract text, edge detection to distinguish boundaries between GUI elements, and/or image segmentation to classify GUI elements. For example, system 110 may use one or more computer vision models to extract one or more features from GUI image data.

At sub-step 218, system 110 may construct LLM prompts based on a structured representation of identified GUI elements. The prompt may describe identified GUI elements, their positions, and/or any identified textual content, enabling the one or more LLMs to infer potential interactions and/or corresponding control commands. In some implementations, the prompt may include information derived from audio data. For example, the prompt may include a transcription of spoken content, an indication that an alert sound was detected, a classification of an audio event, timing information associating the audio event with a corresponding GUI image frame, and/or other information derived from audio data. In some implementations, the prompt may also include contextual metadata, such as image frame timestamps, cursor positions, and/or previously provided control commands and/or GUI states to increase LLM reasoning accuracy.

Identified GUI elements may be represented using various data structures to facilitate processing by the one or more LLMs. For example, text data corresponding to identified GUI elements may be formatted as plain text strings and/or as pairings of labels and values, associating recognized words with their corresponding positions within a given GUI image. Edge detection results may be represented as coordinates defining one or more bounding boxes or other characteristic shapes that may define the boundaries of buttons, menus items, and/or other GUI elements. Image segmentation may be based on processing by one or more neural networks, and may output pixel labels, with one or more pixels or groupings of pixels assigned a category corresponding to a particular GUI element type. For example, one or more pixels or groupings of pixels may be assigned GUI element type “button,” “text field,” and/or “icon.”

In some implementations, system 110 may encode information corresponding to GUI elements into structured representations such as JSON, XML, and/or other schema-based formats. For example, a JSON representation of an identified GUI button may include attributes such as the type, label, position, dimensions, and/or current state of the button within the GUI image. For example, an identified GUI button labeled “Submit” may be represented by variables including its type as “button,” its text label as “Submit,” and its position on the GUI image defined by x and y coordinates. The button's size may also be specified, for example by variables including its width and height in pixels. The button's current state may also be included, for example indicating whether it is enabled or disabled.

Similarly, an identified text input GUI element may be represented by variables that describe its label, position, size, entered text, and/or current state. For example, a JSON representation of an identified GUI text input field labeled “Username” may be represented by variables including its position on the GUI image defined by x and y coordinates, and its width and height in pixels. Further variables may include an entered value variable representing the current state of the input field and/or a selection attribute representing whether the text field is currently selected and/or ready for input.

Using data structures such as those described above, system 110 may generate LLM prompts that serve as inputs to one or more text-based LLMs, such as DeepSeek R1, GPT-4, LLaMA, Claude, and/or Mistral. These models may process the prompts to infer appropriate interactions and generate corresponding commands for computing device operation. In some implementations, prompts may include a spatial mapping of GUI elements, organizing components based on their arrangement and/or functional relationships. This mapping may incorporate identified text, visual attributes such as GUI element color and/or shape, and/or contextual metadata such as image frame timestamps, cursor positions, and/or previously provided control commands and/or GUI states to provide a comprehensive description of the GUI state.

In some implementations, LLM prompts may be constructed in a hierarchical format that organizes GUI elements based on their relationships. For example, a prompt may describe an active application window and its contents, listing sections, interactive and/or noninteractive elements, and/or the state of one or more of the elements. The descriptive portion of an exemplary LLM prompt based on a such a hierarchical format may include the following: “The active window is titled ‘Settings.’ Within this window, there are three sections: ‘General,’ ‘Network,’ and ‘Accessibility.’ The ‘General’ section contains a toggle labeled ‘Dark Mode’ (current state: ON), a dropdown menu labeled ‘Language’ (current setting: ‘English’), and a button labeled ‘Save Changes.’ The cursor position is over the ‘Language’ dropdown menu. Below these elements, there are two buttons: ‘Cancel’ (current status: enabled) and ‘Apply’ (current status: disabled). Basing LLM prompts on such structured textual inputs may allow one or more LLMs to infer interactions and corresponding control commands based on a representation of the GUI state. In the above example, possible interactions may include clicking a dropdown menu to expand available options and/or modifying a setting.

At step 220, system 110 may process the GUI image data using one or more LLMs to determine appropriate interactions with the one or more computing devices and corresponding control commands. The one or more LLMs may analyze the GUI image data, or LLM prompts constructed based on the GUI image data, reason over identified GUI elements, and generate corresponding control commands. In some implementations, the one or more LLMs may identify functional relationships between GUI elements, such as determining that a specific button is associated with form submission or that a text field is intended for a particular type of input. These reasoning processes may enable system 110 to autonomously interact with the one or more computing devices without the use of predefined scripts or manually programmed workflows.

Optionally, at sub-step 222, the one or more LLMs may be executed locally on a processing unit, such as a GPU-based system, without transmitting inference requests to an external computing system, for example without transmitting inference requests to a remote server. To enable such local execution, the memory may store one or more model parameters of the one or more LLMs, enabling execution of the one or more LLMs without data retrieval from an external computing system. Local execution may increase security by ensuring that GUI image data is not transmitted beyond the system, reducing risks associated with network-based LLM processing. Additionally, as discussed above, executing one or more LLMs on a high-performance processing unit, such as a system based on NVIDIA GPUs, Google Tensor Processing Units, and/or Intel Gaudi AI Accelerators, may reduce latency by utilizing specialized processing units such as tensor cores.

At sub-step 224, system 110 may process the GUI image data, and may optionally process the audio data (and/or data derived therefrom), directly using one or more multimodal LLMs. Alternatively or additionally, system 110 may process the LLM prompts constructed at sub-step 218 using one or more text-based LLMs as discussed above. One or more multimodal LLMs may analyze raw GUI images directly using vision-based reasoning to identify and interpret GUI elements and to infer possible interactions. One or more multimodal LLMs may be designed to process and integrate multiple types of data, including text and images, allowing such models to recognize GUI elements, understand contextual relationships, and predict user interactions based on a GUI image data input. For example, one or more multimodal LLMs may convert GUI elements into vector-based and/or numerical representations, enabling the one or more LLMs to analyze spatial relationships, detect patterns, and/or identify functional groupings of GUI elements. System 110 may utilize one or more multimodal LLMs including, for example, OpenAI's GPT-4V, Google Gemini, and/or LLaVA. Such models may be capable of few-shot learning, enabling processing of GUI image data without exposure to extensive training datasets.

Alternatively or additionally, one or more text-based LLMs including, for example, DeepSeek R1, GPT-4, LLaMA, Claude, and/or Mistral, may process LLM prompts formed at sub-step 218 as discussed above. These prompts may provide a hierarchical description of the GUI state, detailing the arrangement of identified GUI elements, their functional relationships, and/or relevant textual content. For example, an LLM prompt may describe a settings window with labeled buttons and dropdown menus, indicating which GUI elements are enabled, disabled, and/or selected. Metadata such as image frame timestamps, cursor positions, selection states, and/or recently provided control commands may additionally or alternatively be included with the prompt to further improve LLM reasoning.

In some implementations, system 110 may select between multimodal and text-based LLM processing methods based on computational constraints and/or task requirements. For example, if GUI image data include a plurality of text-based GUI elements such as forms, menus, and/or labeled buttons, system 110 may prioritize use of computer vision techniques and text-based LLM processing to reduce computational overhead. Conversely, if GUI image data include a plurality of visual elements such as icons, charts, and/or unlabeled graphical controls, a multimodal LLM may be used to analyze raw GUI images and determine interactions based on GUI element type and/or spatial relationships. This adaptive selection may allow system 110 to balance processing speed and resource usage while maintaining reliable interpretation of various GUI states.

Following processing of the GUI image data using one or more multimodal LLMs and/or the constructed LLM prompt using one or more text-based LLMs, system 110 may next generate at least one control command corresponding to at least one interaction with the one or more computing devices. For example, if a given GUI image includes a login form with a username field and a password field, the one or more LLMs may determine that an appropriate interaction would be selecting the username field and entering text and may generate a control command on that basis. Similarly, if an exemplary GUI image contains a confirmation dialog with buttons labeled “OK” and “Cancel,” the one or more LLMs may infer that the appropriate interaction would be to click “OK” to proceed with the intended operation and may generate a control command on that basis. For example, a text-based LLM may generate a control command to move the cursor to a particular button and execute a mouse click.

In some implementations, system 110 and/or the one or more LLMs employed by system 110 may improve their performance over time by analyzing previously provided control commands and/or corresponding GUI states generated in response. In some implementations, the one or more LLMs may generate secondary control commands to retry the action, modify the initial control command approach, and/or seek alternative interaction paths. For example, if a prior attempt to submit a form resulted in an error message, system 110 may adjust a subsequent control command to attempt to correct the issue, for example by entering missing information and/or selecting a different form option. System 110 may monitor the resulting GUI state to confirm the control command adjustment had the intended effect, for example successful form submission, and/or to identify corrective actions. By iterating on past actions and analyzing GUI state changes, system 110 may refine its decision-making processes and improve its accuracy and efficiency when faced with unexpected GUI states. For example, system 110 may monitor GUI image data generated in response to transmitted input data to determine whether the transmitted input data resulted in an expected response. Based on a determination of whether the transmitted input data resulted in an expected response, system 110 may generate at least one second control command.

To support learning from prior interactions, system 110 may store in different ways previously provided control commands and/or GUI states generated in response. In some implementations, a short-term buffer may be used to temporarily retain recent control commands and/or GUI states to help manage immediate interactions and/or a series of sequential interactions. Alternatively or additionally, system 110 may maintain a memory-limited history, allowing system 110 to reference previously provided control commands and/or GUI states within a defined time frame and/or until a certain memory capacity is reached, thereby preventing excessive memory usage. In some implementations, previously provided control commands and/or GUI states may be stored based on unique interaction and/or task types. For example, system 110 may store past login sequences, setting adjustments, and/or workflow executions in distinct locations and/or indexes. Such a storage technique may improve the ability of system 110 to recognize recurring patterns and/or optimize future control commands without conflating unrelated interactions and/or tasks.

In some implementations, system 110 may process, using the one or more LLMs, the output data received from the one or more computing devices to generate at least one control command corresponding to at least one interaction with the one or more computing devices. Processing may be of the received output data and/or may be of data derived from the received output data. In some implementations, such derived data may include data used to form GUI image data, for example structured textual descriptions of GUI elements.

At step 230, system 110 may transform the at least one control command into corresponding input data 240 based on a keyboard communication protocol, a mouse communication protocol, or both. For example, the keyboard communication protocol and/or mouse communication protocol may include a USB Human Interface Device protocol. In some implementations, at optional sub-step 232, transformation of the at least one control command into corresponding input data 240 may involve transforming the at least one control command to a sequence of one or more simulated keystrokes, one or more simulated mouse movements, and/or one or more simulated mouse clicks. A person of ordinary skill in the art will understand that, as used herein, simulated keystrokes, mouse movements, and mouse clicks may refer to generated data representing keystrokes, mouse movements, and mouse clicks that have not actually been physically performed on a physical keyboard or mouse.

In transforming the at least one control command into corresponding input data 240, system 110 may ensure that the generated input data 240 accurately represents the intended at least one control command. For example, a control command to open a dropdown menu may be transformed into a simulated mouse click at GUI coordinates corresponding to the dropdown menu, followed by a simulated mouse movement to navigate available menu options. Similarly, a control command to enter login credentials may be transformed to a sequence of simulated keystrokes corresponding to a username input and/or a password input.

This control command-input data transformation may include additional parameters such as timing delays between simulated keystrokes and/or simulated mouse clicks to mimic human-like input patterns and/or to enable adjustments to control commands based on GUI images received during control command execution. For example, if the position of a GUI button shifts during execution of a control command prior to a planned simulated mouse click of the GUI button, system 110 may modify the coordinates of the simulated mouse click prior to execution of the click to match the new position of the GUI button.

Once generated, input data 240 may be transmitted from system 110 to the one or more computing devices via digital KVM interface 170 of system 110. In some implementations, input data 240 may be transmitted in the form of one or more USB packets. Thus, by processing output data and transmitting input data via a digital KVM interface, system 110 may enable interaction with and/or control of the one or more computing devices without use of a proprietary interface or software installation on the one or more computing devices. Because system 110 may appear as a standard keyboard, mouse, and/or display device to the one or more computing devices, system 110 may operate without modification to computing device settings and/or administrative privileges. This approach may enable compatibility with various operating systems, ensuring that system 110 may function as a direct user replacement.

In some implementations, system 110 may transmit the at least one control command to the one or more computing devices via the KVM interface. Transmission may include the at least one control command and/or may include data derived from the at least one control command. In some implementations, such derived data may include data involved in formation of simulated keystrokes, simulated mouse movements, simulated mouse clicks, and/or USB packets formatted according to one or more standard input protocols. As discussed above, system 110 may generate the at least one control command in a format compatible with the operating system of the controlled computing device, enabling execution of user-like interactions over standard input channels.

In some implementations, exemplary process 200 may operate in a cyclic manner, continuously receiving and processing new GUI image data, generating new control commands, and/or refining interactions based on updated GUI image data. For example, after executing a control command, system 110 may analyze updated GUI image data to determine whether the control command had the intended effect, adjusting subsequent control commands as appropriate.

Additionally, system 110 may enable varying levels of user instruction specificity, supporting both granular command inputs (e.g., “submit the form”) and/or high-level operational directives (e.g., “login and configure the network settings”). These user instructions may be provided to the one or more LLMs as a separate input, additional to prompts corresponding to GUI image data and/or metadata. If a user provides only broad or high-level instructions, the one or more LLMs may generate one or more intermediate-level synthetic instructions to form the above-described separate LLM input. In some implementations, a set of multiple systems may be centrally controlled by a superuser, who may define broad interaction strategies, automation parameters, and/or workflows for individual systems to execute.

If system 110 detects a GUI state that deviates sufficiently from an expected response or from a user's instructions or inferred intent, system 110 may pause the generation of new control commands and seek feedback from the user. For example, if a GUI prompt or unexpected dialog is detected in GUI image data that could alter the intended outcome, system 110 may generate a request for confirmation and/or clarification from the user before proceeding with process 200.

Additionally or alternatively, system 110 may operate as an autonomous agent capable of executing task workflows on one or more connected computing devices without user intervention. For example, the one or more LLMs may interface with one or more task-specific agents installed on system 110 that may coordinate operations across one or more software applications. These one or more task-specific agents may use outputs from the one or more LLMs, along with contextual GUI information, to drive completion of one or more task objectives. For example, task objectives may include opening an enterprise resource application, retrieving data from a spreadsheet, and/or inputting the retrieved data into a web-based form. This agent-based model may allow system 110 to perform meaningful work comparable to that of a human operator including, for example, completing reporting, configuration, and/or data-entry workflows.

In this way, system 110 may replace the function of a user operating a computing device by interpreting task directives, generating corresponding control commands, and/or executing workflows involving one or more software applications. For example, a task directive to “prepare a monthly report” may trigger a series of coordinated operations, such as launching a spreadsheet application, reading performance data, opening an internal reporting tool, and/or submitting results entered into the tool. The one or more LLMs and/or associated one or more task-specific agents may determine the correct application sequences and/or control commands based on learned and/or programmed workflows. In some implementations, system 110 may retry and/or revise steps if intermediate GUI states indicate a divergence from expected responses.

In some implementations, a set of systems may be managed by a centralized control service. This centralized control service may act as a superuser, providing task directives, managing model parameters of the one or more LLMs, and/or coordinating software updates across the set of systems. In some implementations, the parameters, prompts, and/or task directives provided by the centralized control service to the one or more LLMs may be customized per system and/or per business function. For example, systems performing a human resources function may be configured to automate employee onboarding workflows, while other systems performing a finance function may focus on invoice processing. In some implementations, one or more systems may be configured to perform a plurality of business functions. In the above example, for instance, a system may be configured to receive from the centralized control service a set of task directives related to human resources function and a set of task directives related to a finance function. The centralized control service may maintain a database that controls updates to the one or more LLMs, task directives and/or workflows provided to one or more systems of the set of systems, optionally by one or more task-specific agents. Additionally or alternatively, the centralized control service may log outputs from one or more systems of the set of systems for auditing and/or performance tracking purposes. As described above, connectivity between the centralized control service and individual systems may be established via a cellular network interface, allowing the systems to remain air-gapped from their controlled computing devices while receiving configuration and/or task updates.

An exemplary set of systems may connect to a corresponding set of controlled computing devices using standard input and output interfaces, and may not involve software installation on the set of controlled computing devices. In this way, an enterprise may maintain separation between the set of systems orchestrated by the centralized control service and the corresponding set of computing devices. This separation may allow an enterprise to maintain control over computing device parameters including, for example, user permissions, security settings, and/or approved software applications, while offloading task execution to the centralized control service. Such a setup may thus enable the benefit of automated control of computing devices in sensitive environments without the data security risks and/or network dependencies of known software-based solutions for example.

Because the systems may interact with controlled computing devices through standard peripheral interfaces, existing data and/or network security protocols used for human users may be seamlessly extended to the systems, which may access resources in the same manner as a local user. As a result, implementation of disclosed systems may not involve revising authentication frameworks, identity management tools, and/or network access controls. Furthermore, deployment of such systems may be quicker and/or simpler than software-based automation solutions, as deployment may not involve any installation, configuration, and/or administrative access with respect to the controlled computing devices. This may also streamline security protocol management relative to software-based automation, reducing operational overhead and/or security risks associated with software versioning and/or endpoint policy conflicts.

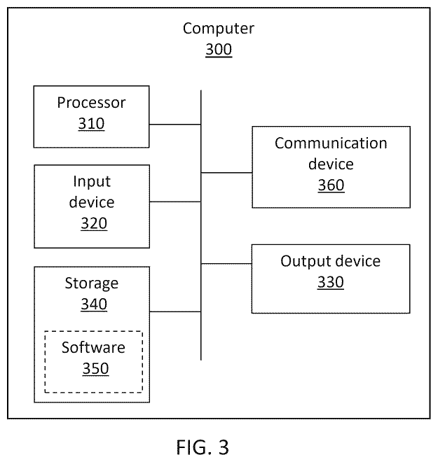

In one or more examples, the disclosed systems and methods utilize or may include a computer system. FIG. 3 depicts an exemplary computing system according to one or more examples of the disclosure. Computer 300 can be a host computer connected to a network. Computer 300 can be a client computer or a server. As shown in FIG. 3, computer 300 can be any suitable type of microprocessor-based device, such as a personal computer, workstation, server, or handheld computing device, such as a phone or tablet. The computer can include, for example, one or more of processor 310, input device 320, output device 330, storage 340, and communication device 360. Input device 320 and output device 330 can correspond to those described above and can either be connectable or integrated with the computer.

Input device 320 can be any suitable device that provides input, such as a touch screen or monitor, keyboard, mouse, or voice-recognition device. Output device 330 can be any suitable device that provides an output, such as a touch screen, monitor, printer, disk drive, or speaker.

Storage 340 can be any suitable device that provides storage, such as an electrical, magnetic, or optical memory, including a random-access memory (RAM), cache, hard drive, CD-ROM drive, tape drive, or removable storage disk. Communication device 360 can include any suitable device capable of transmitting and receiving signals over a network, such as a network interface chip or card. The components of the computer can be connected in any suitable manner, such as via a physical bus or wirelessly. Storage 340 can be a non-transitory computer-readable storage medium comprising one or more programs, which, when executed by one or more processors, such as processor 310, cause the one or more processors to execute methods described herein.

Software 350, which can be stored in storage 340 and executed by processor 310, can include, for example, the programming that embodies the functionality of the present disclosure (e.g., as embodied in the systems, computers, servers, and/or devices as described above). In one or more examples, software 350 can include a combination of servers such as application servers and database servers.

Software 350 can also be stored and/or transported within any computer-readable storage medium for use by or in connection with an instruction execution system, apparatus, or device, such as those detailed above, that can fetch and execute instructions associated with the software from the instruction execution system, apparatus, or device. In the context of this disclosure, a computer-readable storage medium can be any medium, such as storage 340, that can contain or store programming for use by or in connection with an instruction execution system, apparatus, or device.

Software 350 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include but is not limited to, an electronic, magnetic, optical, electromagnetic, or infrared wired or wireless propagation medium.

Computer 300 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 300 can implement any operating system suitable for operating on the network. Software 350 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

1. A system for operating one or more computing devices using a set of one or more large language models (LLM(s)), the system comprising:
a processing unit comprising one or more processors configured to execute the LLM(s);
a keyboard-video-mouse (KVM) interface, wherein the KVM interface is configured to receive output data from the one or more computing devices via a display communication protocol and transmit input data to the one or more computing devices via a keyboard communication protocol, a mouse communication protocol, or both; and
memory storing instructions that, when executed by the one or more processors of the processing unit, cause the system to:
receive output data from the one or more computing devices via the KVM interface;
transform, based on the display communication protocol, the received output data to graphical user interface (GUI) image data;
process, using the LLM(s), the GUI image data to generate at least one control command corresponding to at least one interaction with the one or more computing devices;
transform the at least one control command into corresponding input data based on the keyboard communication protocol, the mouse communication protocol, or both; and
transmit the input data to the one or more computing devices via the KVM interface.

2. The system of claim 1, wherein the processing unit is configured to execute the LLM(s) locally on the processing unit without transmitting inference requests to an external computing system.

3. The system of claim 2, wherein the memory stores one or more model parameters of the LLM(s), enabling execution of the LLM(s) without data retrieval from an external computing system.

4. The system of claim 1, wherein the instructions further cause the system to:
monitor GUI image data generated by the one or more computing devices in response to the transmitted input data to determine whether the transmitted input data resulted in an expected response; and
generate at least one second control command based on the determination.

5. The system of claim 1, wherein the LLM(s) include one or more multimodal LLMs and processing the GUI image data to generate at least one control command comprises analyzing, using the one or more multimodal LLMs, the GUI image data to identify one or more elements of the GUI.

6. The system of claim 1, wherein generating the at least one control command comprises processing audio data received by the KVM interface from the one or more computing devices.

7. The system of claim 1, wherein the instructions cause the system to process the received output data by:
extracting at least one image frame representing a graphical user interface (GUI) of the one or more computing devices;
identifying, using one or more computer vision techniques, one or more elements of the GUI based on the at least one extracted image frame;
constructing a prompt for the LLM(s) based on a textual representation of the identified one or more GUI elements; and
processing the prompt using the LLM(s) to generate the at least one control command corresponding to the at least one interaction with the one or more computing devices.

8. The system of claim 7, wherein the one or more computer vision techniques comprise optical character recognition, edge detection, or both.

9. The system of claim 7, wherein the instructions cause the system to process the prompt using the LLM to generate the at least one control command by determining one or more functional relationships between the identified one or more elements of the GUI.

10. The system of claim 1, wherein the instructions cause the system to transform the at least one control command into corresponding input data based on the keyboard communication protocol by transforming the at least one control command into one or more simulated keystrokes.

11. The system of claim 1, wherein the instructions cause the system to transform the at least one control command into corresponding input data based on the mouse communication protocol by transforming the at least one control command into one or more simulated mouse movements, one or more simulated mouse clicks, or both.

12. The system of claim 1, wherein the transmitted input data comprise one or more USB packets.

13. The system of claim 1, wherein the system further comprises a network communication module configured to connect the processing unit to an external network.

14. The system of claim 13, wherein the external network is separate from a network to which at least one of the one or more computing devices is connected.

15. The system of claim 13, wherein the system further comprises a cellular antenna and the external network comprises a cellular network.

16. The system of claim 13, wherein the processing unit is configured to receive one or more system updates via connection to the external network.

17. A method for operating one or more computing devices using a set of one or more large language models (LLM(s)), the method comprising:
receiving output data from the one or more computing devices via a KVM interface;
transforming, based on a display communication protocol, the received output data to graphical user interface (GUI) image data;
processing, using the LLM(s), the GUI image data to generate at least one control command corresponding to at least one interaction with the one or more computing devices;
transforming the at least one control command into corresponding input data based on a keyboard communication protocol, a mouse communication protocol, or both; and
transmitting the input data to the one or more computing devices via the KVM interface.

18. A non-transitory computer readable storage medium storing instructions for operating one or more computing devices using a set of one or more large language models (LLM(s)), wherein the instructions, when executed by one or more processors of an electronic device, cause the device to:
receive output data from the one or more computing devices via a KVM interface;
transform, based on a display communication protocol, the received output data to graphical user interface (GUI) image data;
process, using the LLM(s), the GUI image data to generate at least one control command corresponding to at least one interaction with the one or more computing devices;
transform the at least one control command into corresponding input data based on a keyboard communication protocol, a mouse communication protocol, or both; and
transmit the input data to the one or more computing devices via the KVM interface.

19. A system for operating one or more computing devices using a set of one or more large language models (LLM(s)), the system comprising:
a processing unit comprising one or more processors configured to execute the LLM(s);
a keyboard-video-mouse (KVM) interface, wherein the KVM interface is configured to receive output data from the one or more computing devices via a display communication protocol and transmit input data to the one or more computing devices via a keyboard communication protocol, a mouse communication protocol, or both; and
memory storing instructions that, when executed by the one or more processors of the processing unit, cause the system to:
receive output data from the one or more computing devices via the KVM interface;
process, using the LLM(s), the output data, or data derived therefrom, to generate at least one control command corresponding to at least one interaction with the one or more computing devices; and
transmit the at least one control command, or data derived therefrom, to the one or more computing devices via the KVM interface.

20. A method for operating one or more computing devices using a set of one or more large language models (LLM(s)), the method comprising:
receiving output data from the one or more computing devices via a KVM interface;
processing, using the LLM(s), the output data, or data derived therefrom, to generate at least one control command corresponding to at least one interaction with the one or more computing devices; and
transmitting the at least one control command, or data derived therefrom, to the one or more computing devices via the KVM interface.

21. A non-transitory computer readable storage medium storing instructions for operating one or more computing devices using a set of one or more large language models (LLM(s)), wherein the instructions, when executed by one or more processors of an electronic device, cause the device to:
receive output data from the one or more computing devices via a KVM interface;
process, using the LLM(s), the output data, or data derived therefrom, to generate at least one control command corresponding to at least one interaction with the one or more computing devices; and
transmit the at least one control command, or data derived therefrom, to the one or more computing devices via the KVM interface.
